(19) United States
(12) Patent Application Publication
(10) Pub. No.: US 2023/0344931 A1
(43) Pub. Date: Oct. 26, 2023

(54) SYSTEM AND METHODS FOR AN ADAPTABLE ELECTRONIC MENU

(71) Applicant: 10353744 Canada Ltd., Kitchener (CA)

(72) Inventor: Mark Church, Waterloo (CA)

(21) Appl. No.: 18/307,128

(22) Filed: Apr. 26, 2023

Related U.S. Application Data
(60) Provisional application No. 63/335,003, filed on Apr. 26, 2022.

(51) Int. Cl. H04M 1/72445; H04M 1/72469; H04M 1/72454; H04M 1/72457

(52) U.S. Cl. CPC H04M 1/72445; H04M 1/72454; H04M 1/72457; H04M 1/72469

(57) ABSTRACT

Systems and methods of ordering from an adaptable menu are provided. The system includes a server to store an adaptable menu of an establishment, an interactive menu request element, a mobile device with a user interface, wherein the mobile device is configured to interact with the interactive menu request element to request and receive a URL for the adaptable menu from the server, a policy file created by a user which includes at least one menu preference of the user, wherein the mobile device is configured to send the policy file to the server to create an adjusted adaptable menu from the adaptable menu based on the at least one menu preference of the policy file, the mobile device configured to receive the adjusted adaptable menu from the server and receive input from the user to place an order, and an establishment device configured to receive the order.

### TECHNICAL FIELD

The embodiments disclosed herein relate to restaurant ordering systems, and, in particular to systems and methods for ordering from adaptable electronic menus.

### INTRODUCTION

Restaurants and other food and beverage-providing establishments currently have a one-size-fits-all approach to menus and ordering. At an eat-in restaurant menus are often hard copies which are used for multiple patrons and present a health and safety issue. These menus and the conventional ordering process create several pain points for patrons, wait-staff, management, and food preparers alike. Conversations between patrons and wait-staff and subsequently wait-staff and food preparers regarding dietary restrictions/requirements are time consuming and confusing. Or in the case of online ordering from an electronic menu the patron may not be able to inform the restaurant of their dietary requirements and preferences or may not have confidence that their instructions will be followed. Ordering food for delivery or takeout can also result in unsatisfactory wait times and interruptions to a patron’s schedule. Mistakes can be costly for both the restaurant and for the patron.

Accordingly, there is a need for a food and/or beverage ordering system which enables quick and safe ordering and empowers the patron to get exactly what they want and/or need.

### SUMMARY

Provided is a system for ordering from an adaptable menu, the system comprising a server to store an adaptable menu of at least one establishment, an interactive menu request element, a mobile device with a user interface, wherein the mobile device is configured to interact with the interactive menu request element to request and receive a URL for the adaptable menu from the server, a policy file created by a user which includes at least one menu preference of the user, wherein the mobile device is configured to send the policy file to the server to create an adjusted adaptable menu from the adaptable menu based on the at least one menu preference of the policy file, the mobile device further configured to receive the adjusted adaptable menu from the server and to receive input from the user to place an order, and an establishment device configured to receive the order from the mobile device.

The system may further include a computing device configured to create the adaptable menu and further configured to send the adaptable menu to the server.

The policy file may include a plurality of masks wherein each mask corresponds to a different at least one menu preference.

The URL may open a web application on the mobile device.

The at least one menu preference may be selected from a group consisting of diet requirements, dietary preferences, macronutrient goals, micronutrient goals, portion preferences, and financial preferences.

The adaptable menu may include a plurality of menu items and wherein the adjusted adaptable menu is created by determining which of the plurality of menu items match the at least one preference of the user. Menu items from the plurality of menu items which do not match the at least one preference of the user may not be shown in the adjusted adaptable menu.

The mobile device may be further configured to provide a real-time GPS location of the user to deliver an order to a current location of the user.

The mobile device may be further configured to provide an estimated time of arrival of the user at a specific location, wherein the delivery establishment delivers an order to the specific location at the estimated time of arrival.

In some embodiments, once the user places the order, funds are held in a bank account of the user until the order has been completed.

The mobile device may store a plurality of policy files created by the user.

A method of ordering from an adaptable menu may comprise storing an adaptable menu, of at least one establishment, on a server, publishing the adaptable menu to a URL, wherein the URL is associated with an interactive menu request element, requesting and receiving the URL from the interactive menu request element by a mobile device, of a user, configured to interact with the interactive menu request element, sending a policy file including at least one menu preference to the server from the mobile device, adjusting the adaptable menu based on the policy file to create an adjusted adaptable menu, receiving the adjusted adaptable menu at the mobile device;, receiving input at the mobile device from the user to place an order; and receiving the order at an establishment device.

The method may further comprise creating the adaptable menu by a computing device and sending the adaptable menu to the server by the computing device.

The policy file may include a plurality of masks corresponding to at least one menu preference and wherein sending the policy file further includes choosing a mask from the plurality of masks.

The adaptable menu may include a plurality of menu items and wherein adjusting the adaptable menu based on the policy file to create an adjusted adaptable menu further includes determining which of the plurality of menu items match the at least one preference of the user.

A global position system (GPS) real-time delivery system may comprise a menu server, configured to store at least one menu of an establishment, an establishment device of the establishment, configured to receive orders and customer information, a mobile device, of a customer, configured to receive at least one menu from the menu server, place an order from the at least one menu including order items and delivery information, and provide customer information including real-time GPS information to the establishment device, wherein the real-time GPS information is provided to the establishment device to adjust the order preparation start time.

The delivery information may be a specific location and the customer information may further include time estimates, wherein the time estimates provide an estimated time of arrival of the customer at a specific location.

The delivery information may include a specific delivery time and the real-time GPS information enables the order to be delivered to the current location of the customer at the specific delivery time.

The order may be delivered by a drone, wherein the drone has an onboard computing device to receive the real-time GPS information for delivering the order to a current location of the customer.

The establishment may be a golf course and the customer may be a patron of the golf course.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a conventional ordering system within a restaurant.

FIG. 2 is a block diagram of an adaptable ordering system within an establishment in according to an embodiment.

FIG. 3 is a flow diagram of a method of using an adaptable ordering system according to an embodiment.

FIG. 4 is a block diagram of data transfer in an adaptable ordering system according to an embodiment.

FIG. 5 is an exemplary policy engine individual menu item entry according to an embodiment.

FIG. 6 is an exemplary menu item interface according to an embodiment.

FIG. 7 is an exemplary order interface according to an embodiment.

FIG. 8 is a block diagram of a GPS delivery scenario according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of embodiments of the present disclosure.

Further, although process steps, method steps, algorithms or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The systems and methods described herein have physical existence and/or manifest a discernible physical effect or change. The systems and methods described herein relate to the manual or productive arts, meaning those arts involving or concerned with applied and industrial sciences. The computer systems described herein have a material effect on the working of the invention and cooperates with other elements of the claimed invention.

Where the computer systems herein are programmed to run an algorithm, the computer processes the algorithm in a novel manner and the processing of the algorithm on the computer solves problems in the functioning of the computer. The computer and the algorithm form part of a single actual invention that solves a problem related to the manual or productive arts. Running the algorithms described herein on the computer improves the functioning of the computer, and the computer and the algorithm together form a single actual invention that solves a problem related to the manual or productive arts.

The following relates generally to a restaurant ordering system, and more particularly to an adaptable ordering system which enables a patron to adjust an electronic menu to their own preferences.

While the present disclosure is directed to an adaptable ordering system for ordering food or beverages from a restaurant, is it to be understood that this is an example context in which the systems and methods can be used. Other applications are contemplated, such as ordering items from a grocery store. The systems and method of the present disclosure may be used more generally for the processing and sharing of a user’s preferences. The systems and methods of the present disclosure may also be used in non-food and beverage applications.

The embodiments of the systems, methods, and devices described herein refer to the use of an “interactive menu request element”. It is to be understood that the interactive menu request element may be any element which enables a user to request to receive a menu at a mobile device. For example, the embodiments of the systems, method, and devices described herein refer to the use of a QR code. It is to be understood that a QR code is one example of how an “interactive menu request element” may be implemented. Such other embodiments are contemplated within the scope of the present disclosure. For example, other encoding systems may be used to similarly encode data in a visual format. Such other encoding systems may use a linear barcode, 2D barcode, color codes, or images with embedded vectors or pixels with encoded data. Generally, information is extracted from the encoded data by a camera system coupled to software for decoding the encoded data imaged by the camera (e.g., QR code software).

The embodiments of the system, methods, and devices described herein refer to “restaurants”, “food”, “servers”, and “preparers”. It is to be understood that any establishment which may receive a customized order from a customer and then prepare and bring that order to the customer may be contemplated herein. The embodiments of the system, methods, and devices described herein refer to “deliver”, “delivering”, “delivery”, “takeout”, and “eat-in” but it is to be understood that any method of getting an order to a customer may be contemplated herein, including but not limited to, walking, driving a car, riding a bike, automated drone delivery, or manual drone delivery.

The embodiments of the system, methods, and devices described herein sometimes refer to a “patron”, “customer”, or to a “user”. It is to be understood that “patron”, “customer”, and “user” are used where it is most appropriate for context, are interchangeable, and refer to the person who is creating an order from an establishment using their mobile device as described herein.

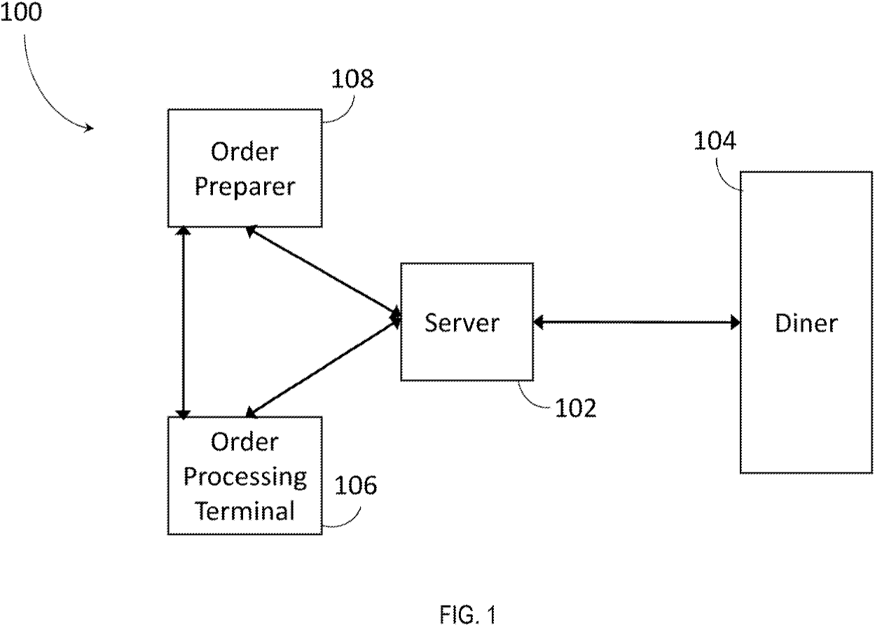

Referring to FIG. 1, illustrated therein is a conventional ordering system 100 within a restaurant.

The system 100 includes a server 102, a diner 104, an order processing terminal 106, and an order preparer 108. This exemplary conventional ordering system is simplified. It is to be understood that a restaurant (or similar establishment) may include multiple servers, multiple diners, and multiple order preparers. In system 100, the server 102 provides a menu to the diner 104 and subsequently interacts with the diner 104 to receive and order from the diner 104. These interactions may include the diner 104 asking the server 102 questions about various items on the menu, such as whether an item includes specific ingredients which the diner 104 is allergic to or does not like, the size of the item, etc. It is important to the diner 104 that their dietary requirements or preferences be accommodated. The server 102 may not have all of the information required and may need to go discuss with the order preparer 108 or other staff of the restaurant to get the information or to inform the diner 104 that the information is not available. Once the order of the diner 104 has been taken by the server 102, the server inputs the order into an order processing terminal 106. This terminal may be computer based wherein the server 102 inputs the order through a user interface on one terminal and the order is relayed to the order preparer 108 through a second terminal with a user interface. The order processing terminal may also just be a location where the server 102 leaves an order on a piece of paper for the order preparer 108 to read. The server 102 may fail to accurately capture the order of the diner 104 resulting in an incorrect order. There is no mechanism in place for the server 102 and the diner 104 to confirm that the order has been correctly captured or correctly relayed to the order preparer 108 through order processing terminal 106. These incorrect orders may result in negative consequences such as impacts on the health of the diner 104 or conflict between the diner 104 and the restaurant.

Issues with ordering also arise in conventional ordering systems for ordering for delivery or takeout. If ordering over the phone the diner still needs to interact with a server to get answers to any questions regarding the menu and an issue may be incorrectly captured or incorrectly relayed to order preparers. If ordering online the diner may only interact with an online menu which does not have an adequate description of all of the ingredients in an item or does not have a mechanism for requesting substitutions. As a result, the diner may simply not order from the restaurant.

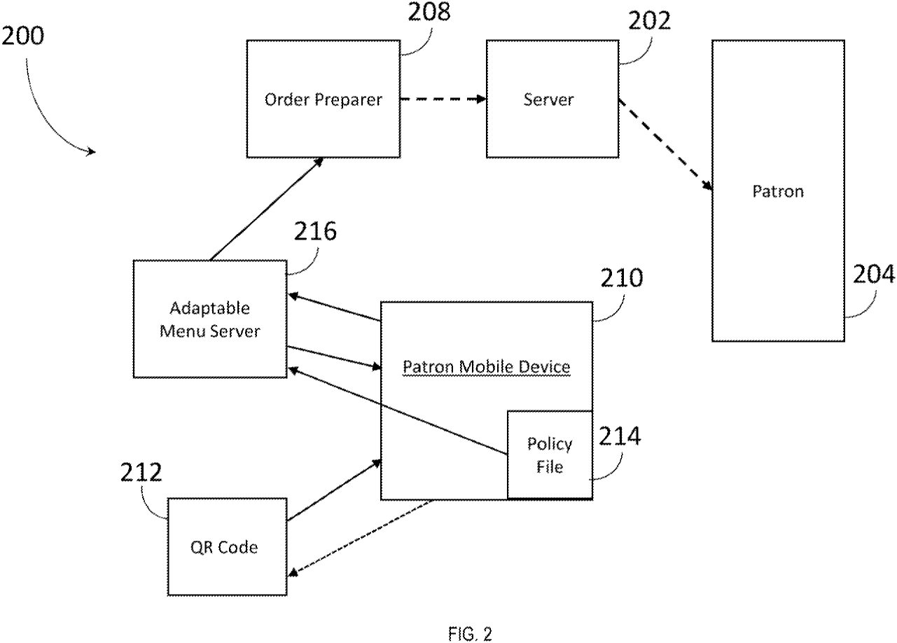

Referring to FIG. 2, illustrated therein is a block diagram of an adaptable ordering system 200 within an establishment.

Adaptable ordering system 200 includes a patron 204 with a mobile device 210, a server 202, an order preparer 208, a QR code 212, and an adaptable menu server 216. Data transfer is denoted by solid arrows. Food (or other order) transfer is denoted by dashed arrows.

Mobile device 210 includes a policy file 214. Policy file 214 includes encoded preferences of the patron 204. The policy file 214 is stored locally on the mobile device 210 and any information, personal or otherwise, contained within the policy file is secure and inaccessible by the restaurant or its employees. The preferences within the policy file may include overall diet preferences such as omnivore, vegetarian, vegan, pescatarian, gluten-friendly, etc., dietary requirements such as gluten-free, specific allergen-free (or ingredients to which the patron is sensitive), etc., and/or nutrition preferences such as limits for amounts of carbohydrates, protein, fats, sodium, kilocalories, etc. The policy file may have access to information regarding what other food the patron has consumed that day or that week (e.g., the policy file could be linked to a diet monitoring application) and may provide recommendations based on nutritional allowances for the day/week.

In some embodiments, the policy file may include food type preferences such as salads over sandwiches. The policy file may show certain foods at certain times of the day, e.g., breakfast foods before 11 am. The policy file may adapt over time to the observed preferences of the patron and display certain menu items more prominently (e.g., show them at the top of the menu) at certain times of day or on certain days of the week. The patron may be able to prioritize which preferences are more important than others, e.g., calories more important than sodium, price more important than size, etc.

In yet other embodiments, a patron may have multiple policy files for different circumstances. For example, a patron may be attending a company meal wherein the company has mandated cost limits or alcohol limits. The patron may apply those limits to their own policy file, the company may provide a policy file to the patron, or the company may provide a menu to the patron which has been adjusted based on a company policy file.

In yet other embodiments, the patron may have policy files for multiple people (e.g., their family) on their mobile device and may receive an adjusted adaptable menu for each person to choose from or to choose from for each person.

In yet other embodiments, the policy file may identify the patron as a member of a specific group such as a VIP (very important person) to the particular restaurant or have information regarding the patron’s involvement in a loyalty program with the restaurant.

In yet other embodiments, the policy file may include information regarding payment methods and tip policies.

Patron 204 uses patron mobile device 210 to interact with QR Code 212 to receive a URL (In FIG. 2, scanning of the QR code is represented by a dotted arrow). Patron mobile device 210 opens the URL to a web application in a browser (for example a mobile browser such as Chrome or Safari). Patron 204 interacts with the web application to request an adaptable menu from adaptable menu server 216. Policy file 214 is applied to the adaptable menu, wherein the patron 204 receives an adjusted adaptable menu from adaptable menu server 216 at patron mobile device 210 which has been adjusted to the preferences of patron 204. In some embodiments the policy file 214 is automatically applied to the adaptable menu before the adjusted adaptable menu is received at the patron mobile device 210, that is, the policy file 214 is “pulled” from the patron mobile device 210 to adjust the adaptable menu. In other embodiments the policy file 214 may be applied to the adaptable menu “manually” by the patron 204 after the adaptable menu is received at the patron mobile device 210 to create the adjusted adaptable menu, that is, the policy file 214 is “pushed” by the patron 214 to adjust the adaptable menu.

The policy file 214 may be applied to the adaptable menu by a policy engine on menu server 216. The adaptable menu may be stored on menu server 216 as individual menu item entries. The encoded preferences of policy file 214 are applied to the individual menu item entries of the adaptable menu by the policy engine to determine which individual menu item are complete matches, partial matches, or mismatches with policy file 214.

It is to be understood that QR code 212 is an example of an interactive menu request element and that in other embodiments the patron 204 may interact with any numbers of other elements, such as an NFC reader. In some embodiments, the QR code may be specific to a table in a restaurant and order preparation may begin only once all orders for that table have been placed. In other embodiments, the QR code may be specific to a single seat within a restaurant.

The adjusted adaptable menu to which the policy file has been applied may show only menu items which match the policy file 214. In other embodiments any number of configurations of an adjusted adaptable menu can be contemplated. In some embodiments, some preferences may allow for incomplete or partial matches to still be shown. For example, lower calories options may be listed first while options which put a patron over their daily calorie limit may still be shown but listed last. In some embodiments, the adjusted adaptable menu may somehow identify matches of the policy file 214 while still showing menu items which do not match the policy file 214, e.g., matches highlighted and mismatches shown as greyed out. In yet other embodiments, the policy file may include a list of menu items which the patron has enjoyed in the past and those items may be shown first or tagged as “liked” in some manner, while items that the patron disliked may be removed or tagged as “disliked” in some manner.

The patron 204 makes selections of what items they want to order from the adjusted adaptable menu. If the menu item is customizable, the patron 204 may manually adjust their selected item. Alternatively, the menu item may have been customized when the policy file was applied to the adaptable menu to reflect the preferences or previous choices of the patron 204. For example, the menu item may have been adjusted to accommodate a calorie limit preference or an allergy, or the menu item may have been adjusted to choose salad instead of fries as a side because the patron 204 usually orders salad over fries. The adjustable preferences within a menu item may be discrete or scalable. For example, discrete options may be “none”, “half”, “all” or “0 g” “50 g”, “100 g”, while a scalable option may be presented as a choice of anywhere between 0 and 100 g of an item. In some embodiments, as the patron 204 makes selections they may be shown the effects of their choices on their daily/weekly goals or nutritional goals for a single meal. For example, the patron 204 may be shown a running tally of the calories or amount of sodium in the menu item as they move between discrete options or scalable amounts.

Once the patron 204 has completed their selections and any manual adjustments to their selections, patron 204 sends their order to adaptable menu server 216. The order is then received by the order preparer 208. The order may be received by the order preparer 208 at an order preparer device with a user interface. In other embodiments, the order may be received by the order preparer 208 as a hard copy which has been printed out. In another embodiment, the order may be sent to a different server or device than adaptable menu server 216.

Once the food (or other type of item sold by the restaurant) is prepared the server 202 receives the order and brings it to the patron 204.

In some embodiments, the patron may be prompted to rate their experience or their order at a certain time after their dining experience is over.

In an embodiment where the patron requires takeout or delivery instead of eat-in, the patron may access the web application through a URL they can find on a webpage or in an email. Alternatively, a QR code may be provided on a webpage or on a flyer or other advertisement.

In another embodiment, the patron does not have a policy file and instead manually adjusts the adaptable menu. In this embodiment the web application would include a method by which the patron could select dietary or nutritional preferences or input allergies or sensitivities. In some embodiments, all three options of having a policy file “pulled” from a mobile device before a menu is received, “pushing” the policy file to adjust the menu after is has been received, or manually adjusting the menu may exist for the patron.

When ordering within an establishment the web application may include a means for requesting that a server come to the location of the patron to answer any outstanding questions. When ordering from within or without an establishment the web application may include a chat function (communication by text or voice) or video function which enables the patron to interact with a server to answer any outstanding questions. The web application may also include the ability to share pictures, videos, and other updates between the restaurant and patrons.

The benefits of the adaptable ordering system are many. Customers may have increased satisfaction with their orders and with the experience as they will receive exactly what they want and need because the likelihood of mistakes being made in the ordering process is greatly reduced. Conflicts between customers and restaurant staff may be reduced. Electronic menus eliminate or reduce the need for hard copies of menus which pose a health risk unless cleaned between each use. An electronic menu may be presented to a patron in another language of their choosing, eliminating language barriers. Because the customer is able to order exactly the amount of food they want there is less food waste.

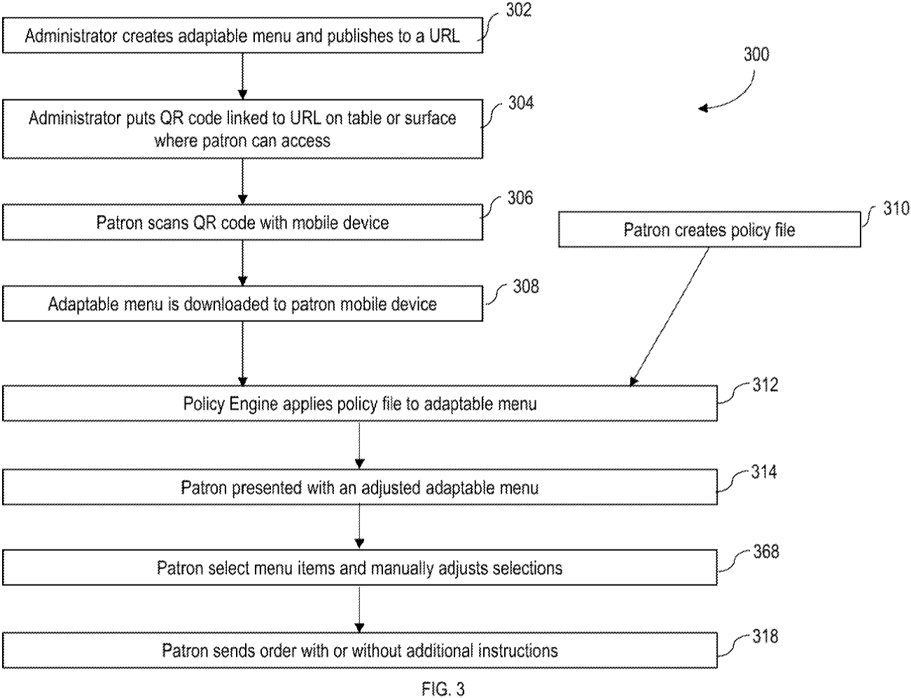

Referring to FIG. 3, illustrated therein is a flow diagram of a method 300 of using an adaptable ordering system according to an embodiment. Method 300 describes the steps required to operate and use an adaptable ordering system. Method 300 is similar to the method of operation of adaptable ordering system 200 in FIG. 2.

At 302, an administrator creates an adaptable menu and publishes the menu to a URL. The adaptable menu may be stored to an adaptable menu server similar to adaptable menu server 216 of FIG. 2.

At 304, the administrator places a QR code linked to the URL on a table or surface where the patron can access the QR code. Other examples include, but are not limited to, the QR code could be outside the restaurant so a patron can look at the menu before entering or the QR code could be on a flyer which is mailed to customer’s home.

At 306, the patron scans the QR code using their mobile device.

At 308, the adaptable menu is downloaded to or opened on the patron’s mobile device.

At 310, the patron creates a policy file, like policy file 214 of FIG. 2, which is encoded with the dietary and nutritional preferences of the patron and/or financial preferences. The policy file may also include prioritizations of the various preferences therein, e.g., calories preferences are more important than sodium preferences. The policy file is stored locally on the mobile device of the patron. It is to be understood that the policy file is not necessarily created during an ordering process for the patron but may have been completed and stored on the mobile device well in advance of the patron starting to place an order.

At 312, the policy file is applied to the adaptable menu by a policy engine. The policy engine uses all of the encoded preferences and prioritizations of the policy file and all of the individual menu item entries of the adaptable menu as inputs to output an adjusted adaptable menu which best reflects the encoded preferences of the policy file.

More specifically, the encoded preferences and prioritizations of the policy file act as a set of rules which represent software logic implemented by the policy engine. As described above, the encoded preferences and prioritizations may be representations of diet restrictions/requirements (e.g., allergies, gluten-free, sensitivities, etc.), dietary preferences (e.g., vegan, vegetarian, pescatarian, gluten-friendly), nutritional preferences (limits/goals for macronutrients or micronutrients), ingredients to avoid (based on taste, texture, etc.). The preferences and prioritization may include financial preferences such as price of items. The nature of these preferences is not particularly limited. These encoded preferences and prioritizations are applied to the individual menu item entries of the adaptable menu as rules to determine if the individual menu item entry is a complete match (e.g., passes all preferences), partial match (e.g., passes some preferences but not others which are not required or not as highly prioritized), or a mismatch (e.g., does not pass a required preference).

The policy file preferences and prioritizations can be updated at any time by the patron. The policy file may include a plurality of masks, where each mask corresponds to a particular set of preferences and/or prioritizations. The masks may be specific to an establishment or to a time of day/day of the week. The masks may represent different people, for example, a patron may wish to order for their family and may apply a different mask for each member. The masks may be automatically applied or the patron may choose a particular mask.

At 314, the patron is presented with an adjusted adaptable menu customized by the policy file preferences. In one embodiment, scanning the QR code at step 306 may take a patron directly to a web application which displays an adjusted adaptable menu which has already had the policy file applied. In this embodiment the policy file is “pulled” from the mobile device when the QR code is scanned and the patron has pre-consented to sharing the use of the policy file. Alternatively, the patron may be prompted to consent to having the policy file “pulled” after the QR code is scanned but before any menu is received. In a second embodiment, the URL may take the patron to a webpage or web application which displays an unadjusted adaptable menu and from which the patron can request an adjusted adaptable menu. In the second embodiment, the patron “pushes” the policy file to be applied to the adaptable menu to create their adjusted adaptable menu. In another implementation, the unadjusted adaptable menu can be sent to the device, where the policy file can be applied by a process running on the mobile device.

At 316, the patron makes menu selections and manually adjusts the selections, if necessary. As discussed above in reference to FIG. 2, there may be options for a menu item which need to be chosen by the patron. These options may include, but are not limited to, choosing between sides, e.g., fries or salad, or choosing quantities of an item, e.g., small, medium, or large, or a certain number of grams, be that based on nutritional goals or hunger.

At 318, the patron finalizes their menu selections and sends the order with or without additional instructions. Additional instructions can include anything which was not covered by the preference choices included in the adaptable menu or the policy file of the patron. For example, the patron may wish for a certain item to be a certain temperature or for a starter to be brought out at the same time as a main.

In another embodiment, a similar method to method 300 may be employed but an adaptable menu may be adjusted “manually” by a patron after receiving the adaptable menu at a mobile device of the patron. In this embodiment, the patron does not have a policy file which is applied to the adaptable menu and instead applies their preferences manually within a web application to create an adjusted adaptable menu.

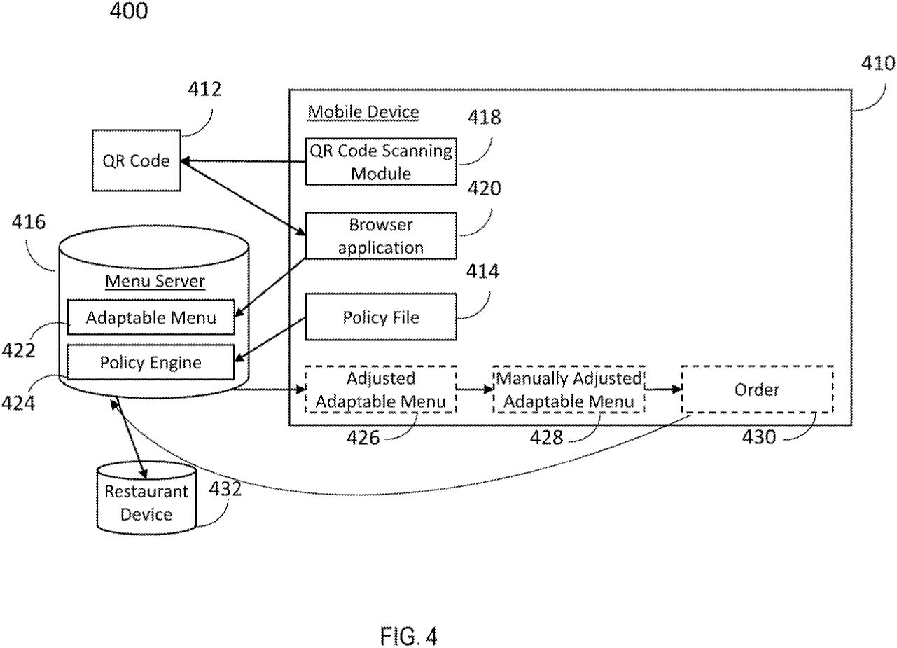

Referring to FIG. 4, illustrated therein is a block diagram of an adaptable ordering system 400 including a policy engine according to an embodiment. Adaptable ordering system 400 includes a mobile device 410 of a patron, a QR code 412 of an establishment, a menu server 416, and a restaurant device 432 of the establishment. Adaptable ordering system 400 operates similarly to method 300.

Mobile device 410 further includes a QR code scanning module 418, a browser application 420 to run a web application, and a policy file 414. Menu server 416 includes an adaptable menu 422 and a policy engine 424 to apply the policy file 414 to the adaptable menu 422.

QR code scanning module 418 is used by the patron to scan QR code 412. Mobile device 410 receives a URL upon scanning QR code 412 and opens the URL as a web application using browser application 420. The patron views the web application through a user interface of mobile device 410.

The patron requests an adjusted adaptable menu 426 from the menu server 416. The policy file 414 of the patron which is locally stored on mobile device 410 is sent to menu server 416. The policy engine 424 on the menu server 416 applies the preferences of policy file 414 to individual menu item entries of adaptable menu 422 which are stored on menu server 416 to create adjusted adaptable menu 426. Adjusted adaptable menu 426 is sent to mobile device 410. The patron can view adjusted adaptable menu 426 in browser application 420.

In other embodiments, the request of the adjusted adaptable menu 426 from menu server 416 may occur automatically upon scanning of QR code 412 such that policy file 414 is sent automatically to menu server 416. The patron would then receive adjusted adaptable menu 426 without a manual request from within browser application 420 and would be able to view adjusted adaptable menu 426 within browser application 420 immediately upon scanning QR code 412. In yet other embodiments, upon opening the URL on mobile device 410 the patron may be asked for consent to send policy file 414 to menu server 416 but may not be required to manually request adjusted adaptable menu 426.

The patron views menu items of adjusted adaptable menu 426. The patron may then interact with the various menu items to manually adjust the menu items and decide what they want to order. The interaction of the patron with individual customizable menu items may be similar to those interactions described in the discussion of FIG. 2 above. The patron may also manually adjust the menu as a whole, e.g., the patron may choose to override the nutritional preferences of policy file 414 and see all menu items which fulfill every preference except sodium content.

The patron then chooses which menu items they would like to order and places an order. The order is sent to menu server 416 and then to restaurant device 432 where it can be viewed on a user interface of restaurant device 432 by an order preparer of the establishment.

In other embodiments, the order may be sent directly to the restaurant device 432. In yet other embodiments, the order may be sent to another device or server other than restaurant device 432 or menu server 416 before being received by the order preparer.

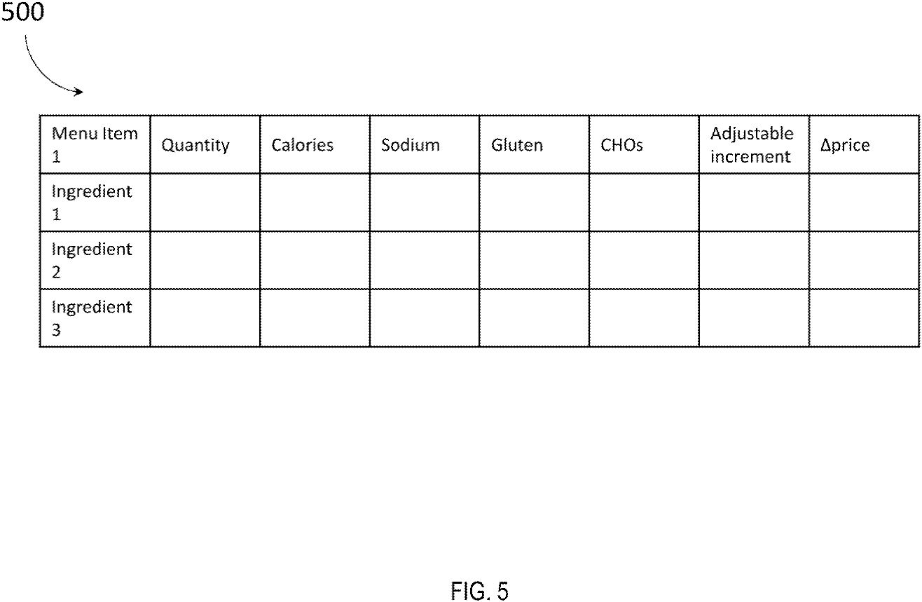

Referring to FIG. 5, illustrated therein is an exemplary policy engine individual menu item entry 500 according to an embodiment.

Individual menu item entry 500 includes all of the information necessary for the policy engine to make a determination for a given menu item of a complete match, partial match, or a mismatch for the preferences and prioritizations included in a policy file of a patron. Entry 500 includes the name of the menu item (shown as menu item 1) as well as each ingredient (shown as ingredients 1, 2, and 3) which makes up the menu item. For each ingredient the quantity (e.g. grams of the ingredient), calories (i.e. the amount of kilocalories present in quantity of the ingredient), sodium (amount of sodium in quantity of ingredient), gluten (yes/no or amount of gluten in quantity of ingredient), carbohydrates (CHOs; amount of carbohydrates in quantity of ingredient), adjustable increment (how can the amount of this ingredient change), and change in price (how would adjusting this ingredient based on the adjustable increment change the price of the menu item).

In some embodiments, the adjusted adaptable menu output by the policy engine may include only complete matches. In other embodiments, the policy file may prioritize certain preferences as “must have/must not have” and other as “nice to have/nice to not have” and the adjusted adaptable menu may therefore include complete matches which have both “must have/must not have” and “nice to have/nice to not have” and partial matches that only have the “must have/must not have” but not the “nice to have/nice to not have”.

In some embodiments the menu may only show complete/partial matches with mismatches not shown. In other embodiments all menu items may be shown but shown in a way which displays the menu item’s status as a complete or partial match or not a match at all. For example, complete matches shown first, followed by partial matches, and mismatches shown at the end of the menu. Or complete matches shown in green, partial matches in yellow, and mismatches shown in red. It may be the prerogative of the patron what combination of complete matches, partial matches, and mismatches are shown in the adjusted adaptable menu. For example, the patron may include in their policy file that they only want to be shown complete matches or that they want to continue to see all menu items.

In some embodiments, when the adjusted adaptable menu is sent to the patron, certain menu items may have been pre-customized by the policy engine. That is, a menu item may require customization to be a complete or partial match and those customizations may be applied to the adjusted adaptable menu so that the patron receives an adjusted adaptable menu with the menu items in a state that complies with their preferences. For example, a sandwich may have gluten-free bread chosen as an option or salad may have been chosen over fries as a side to minimize calories or sodium.

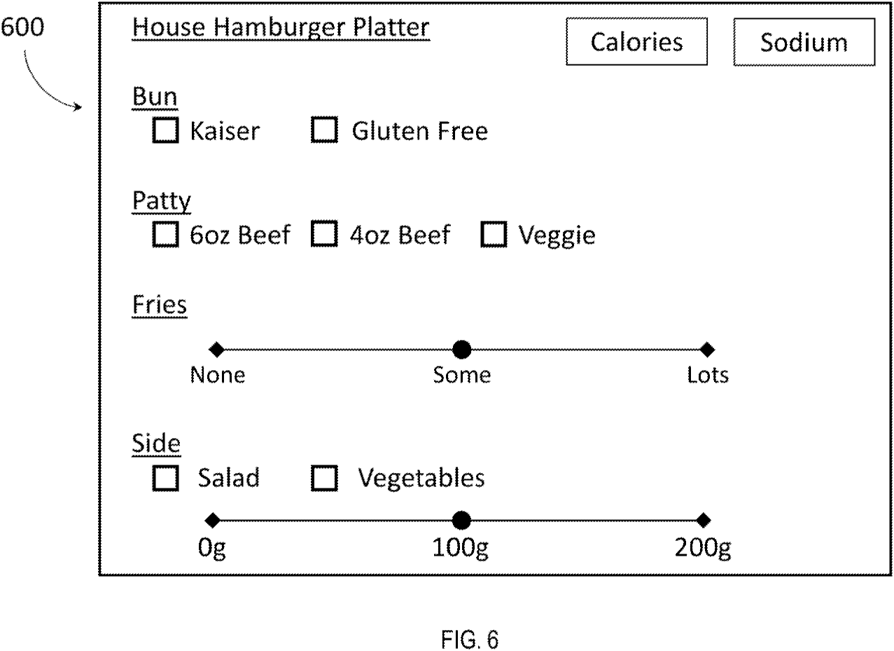

Referring to FIG. 6, illustrated therein is an exemplary menu item interface 600 according to an embodiment.

The menu item interface 600 is for a “house hamburger platter”. This menu item may have been shown to the patron as a complete match with their policy file, as a partial match with their policy file, or as a mismatch with their policy file.

The “house hamburger platter” has several customizable options. The patron must choose between a kaiser bun or a gluten-free bun. The patron must choose between a 6oz beef patty, a 4oz beef patty, and a veggie patty. The patron must choose whether they would like no fries, some fries, or lots of fries. The patron must choose whether they would like salad or vegetables as a side and how many grams of that side they would like.

The patron chooses their options by either checking a box beside their chosen option or sliding an indicator along a bar to their chosen option. The sliding bar may have discrete locations which may be chosen, for example the fries in FIG. 6 may only be ordered at “none”, “some”, or “lots”, or the indicator may be positioned at any location on the bar, for example, the side of FIG. 6 may be ordered at any value between 0-200 g. When the indicator may be placed at any position for a quantitative amount there may be an indication on the interface of the exact amount being ordered. For example, it may be shown in a box beside the sliding bar that the patron is ordering exactly 30 g of vegetables.

Menu item interface 600 also includes boxes indicating the total amount of calories (kcal) and sodium in the customized menu item. For each item that is chosen and the amount chosen (where applicable) the number of calories and sodium will appear in the boxes. As the patron customizes the item there may be an indication that the calories/sodium are under the preference limits, within the preference limits, or over the preference limits. For example, the box may be yellow when under limits, green when within limits, and red when over limits.

In other embodiments there may be other boxes indicating nutritional limits or goals. For example, there may be a box showing the total fats or trans fats in the menu item.

In other embodiments, certain options for the menu item may be unavailable or not shown. For example, with the house hamburger platter if the patron’s policy file indicated that the patron eats a vegetarian diet, the beef patty options would not be shown or would be shown but unable to be chosen as an option. The slidable bars may be limited in their scope. For example, fries may be an option but only in the amount of “none” or “some” and not “lots”.

If the patron is ordering more than one menu item, the interface may include a running tally of the various nutrition amounts which are important to the patron. For example, the patron may have chosen a milkshake as a beverage already and therefore the calories shown on the house hamburger platter interface 600 will include the calories of the milkshake as well as the calories of the currently entered options regarding the house hamburger platter. Alternatively, with the milkshake already chosen the calories box on the interface may show only the calories for the house hamburger platter but the limits at which the box turns yellow, green, or red will be adjusted to reflect the calories from the milkshake.

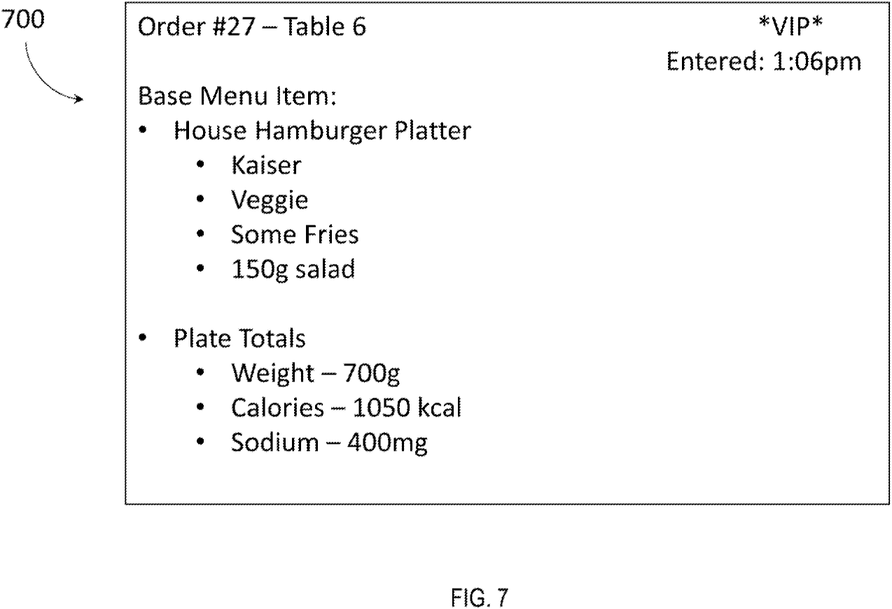

Referring to FIG. 7, illustrated therein is an exemplary order interface 700 according to an embodiment.

Order interface 700 shows an example order from a patron. Order interface 700 is seen by an order preparer of the establishment which is taking the order. The order is Order #27 and is to be delivered to table 6. The order was entered at 1:06pm. The order indicates that the patron is a VIP (very important person) to the establishment. VIP status may indicate any number of things to the establishment, for example, that this is a returning customer who eats at the establishment frequently. The menu item ordered is from the house hamburger platter menu item interface 600 of FIG. 6. The patron has chosen to order a house hamburger platter with a kaiser bun, a veggie patty, “some” fries, and 150 g of salad. The plate totals associated with this meal are 700 g total, 1050 kcal, and 400 mg of sodium. This order may be visible to the order preparer on a user interface of a restaurant device or may be printed off as a hard copy and displayed somewhere for the order preparer to view.

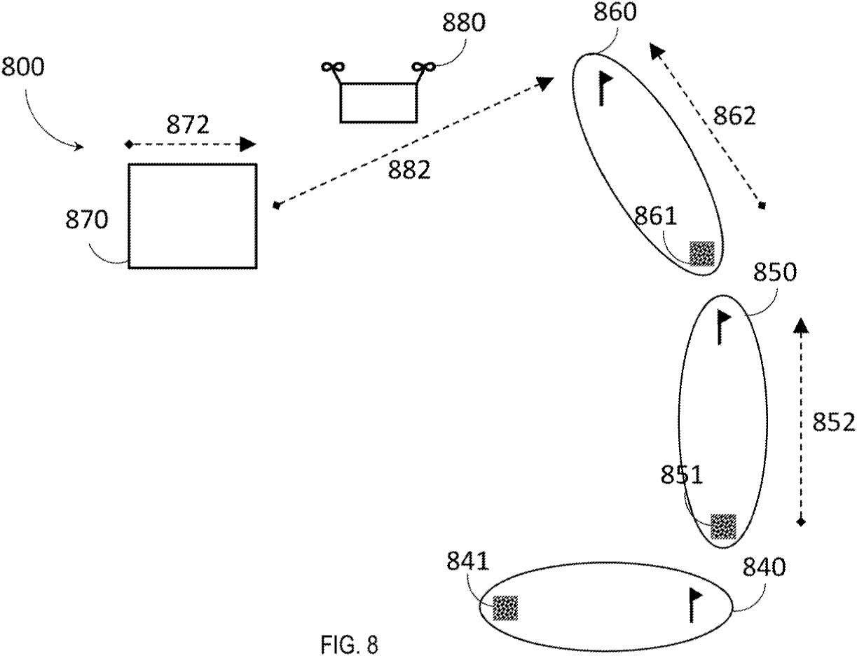

Referring to FIG. 8, illustrated therein is a block diagram of a GPS delivery system scenario 800 according to an embodiment.

GPS delivery system scenario 800 is at a golf course. Shown are three holes 840, 850, and 860. Each hole has a QR code 841, 851, and 861 respectively at the tee end of the hole. The golf course has a restaurant 870 which provides drone delivery by drone 880 to certain locations on the course. The GPS delivery system uses an estimate of various completion times to determine an estimated time that a patron will be at a certain location in order to prepare the order and deliver it to the location on time.

In GPS delivery system scenario 800, the patron scan QR code 851 to order some food. The patron may “push” their policy file to an adaptable menu server or may allow their policy file to be “pulled” by the adaptable menu server, as described above. An adjusted adaptable menu is received by the patron at their mobile device and they place an order that they wish to receive once they have completed hole 860. The GPS delivery system is able to estimate a time 852 which the patron will take to complete hole 850, a time 862 which the patron will take to complete hole 860, a time 872 for the order to be prepared, and a time 882 which the drone 880 will take to arrive at the green of hole 860. The GPS delivery system can then estimate a time to begin preparing the order to complete delivery at the correct location and on time. For example, if the time of the order were 2:30pm, the time to complete hole 850 averages 15 minutes (time 852), and the time to complete hole 860 averages 18 minutes (time 862) then the target delivery time would be 3:03pm (2:30pm + time 852 + time 862). If the time to prepare the order is 10 minutes (time 872) and the time for the drone 880 to reach the end of hole 860 is 5 minutes (time 882), which a total order preparation and delivery time of 15 minutes (time 872 + time 882) then the order must begin to be prepared no later than 2:48pm (15 minutes before 3:30pm). However, the GPS delivery system will continue to update the location and time estimates of the patron so that the order preparer can adjust the order preparation start time and, if necessary, adjust the location at which the drone delivers the order. This system can be used for other use cases, for example ordering food from a food delivery service on the way home: the time for the patron to arrive at a specific destination and the time for preparation and delivery of the food can be calculated and preparation start time adjusted so that the food and patron arrive at the same time.

In a basic GPS real-time delivery system, the customer receives a menu from a menu server and places an order to an establishment which includes order items (e.g., food items) and delivery information. The order is received at a computing device of the establishment, or “establishment device” at which the user wishes to place an order. The establishment device receives real-time GPS information (this may be continuous or continual updates) from the mobile device of the patron (“customer”) in order to adjust an order preparation start time to meet the delivery information. In one scenario, the delivery information includes a specific delivery time at which the customer would like to receive their order and the real-time GPS information enables the establishment to track where the user is and to determine when they need to start preparing the order in order to get the order to the real-time current location of the customer as their chosen delivery time. In another scenario, the delivery information includes a specific delivery location where the customer would like to receive their order and the mobile device further provides an estimated time (e.g., multiple estimates over time as the customer moves around) at which the customer will be at the specific delivery location to the establishment device to adjust the order preparation start time. In some scenarios, the delivery information may include both a specific delivery location and a specific delivery time. In some embodiments, the order is delivered by a drone and the drone has an onboard computing device to receive the real-time GPS information for delivering the order to a current location of the customer.

In some embodiments of the above systems and methods, funds may be held in a bank account of the patron until the order has been completed. This protects both the patron and the establishment from which they ordered. The patron because, if the food does not arrive, they do not lose the funds. And the establishment because the funds are guaranteed upon completion as the patron cannot use the money before it is due to the establishment.

While the above description provides examples of one or more apparatus, methods, or systems, it will be appreciated that other apparatus, methods, or systems may be within the scope of the claims as interpreted by one of skill in the art.

1. A system for ordering from an adaptable menu, the system comprising:
a server to store an adaptable menu of at least one establishment;
an interactive menu request element;
a mobile device with a user interface, wherein the mobile device is configured to interact with the interactive menu request element to request and receive a URL for the adaptable menu from the server;
a policy file created by a user which includes at least one menu preference of the user, wherein the mobile device is configured to send the policy file to the server to create an adjusted adaptable menu from the adaptable menu based on the at least one menu preference of the policy file;
the mobile device further configured to receive the adjusted adaptable menu from the server and to receive input from the user to place an order; and
an establishment device configured to receive the order from the mobile device.

2. The system of claim 1 further comprising a computing device configured to create the adaptable menu and further configured to send the adaptable menu to the server.

3. The system of claim 1 wherein the policy file includes a plurality of masks wherein each mask corresponds to a different at least one menu preference.

4. The system of claim 1 wherein the URL opens a web application on the mobile device.

5. The system of claim 1 wherein the at least one menu preference is selected from a group consisting of diet requirements, dietary preferences, macronutrient goals, micronutrient goals, portion preferences, and financial preferences.

6. The system of claim 1 wherein the adaptable menu includes a plurality of menu items and wherein the adjusted adaptable menu is created by determining which of the plurality of menu items match the at least one preference of the user.

7. The system of claim 6 wherein menu items from the plurality of menu items which do not match the at least one preference of the user are not shown in the adjusted adaptable menu.

8. The system of claim 1 wherein the mobile device is further configured to provide a real-time GPS location of the user to deliver an order to a current location of the user.

9. The system of claim 1 wherein the mobile device is further configured to provide an estimated time of arrival of the user at a specific location, wherein the delivery establishment delivers an order to the specific location at the estimated time of arrival.

10. The system of claim 1 wherein once the user places the order funds are held in a bank account of the user until the order has been completed.

11. The system of claim 1 wherein the mobile device stores a plurality of policy files created by the user.

12. A method of ordering from an adaptable menu, the method comprising:
storing an adaptable menu, of at least one establishment, on a server;
publishing the adaptable menu to a URL, wherein the URL is associated with an interactive menu request element;
requesting and receiving the URL from the interactive menu request element by a mobile device, of a user, configured to interact with the interactive menu request element;
sending a policy file including at least one menu preference to the server from the mobile device;
adjusting the adaptable menu based on the policy file to create an adjusted adaptable menu;
receiving the adjusted adaptable menu at the mobile device;
receiving input at the mobile device from the user to place an order; and
receiving the order at an establishment device.

13. The method of claim 12 further comprising:
creating the adaptable menu by a computing device; and
sending the adaptable menu to the server by the computing device.

14. The method of claim 12 wherein the policy file includes a plurality of masks corresponding to at least one menu preference and wherein sending the policy file further includes choosing a mask from the plurality of masks.

15. The method of claim 11 wherein the adaptable menu includes a plurality of menu items and wherein adjusting the adaptable menu based on the policy file to create an adjusted adaptable menu further includes determining which of the plurality of menu items match the at least one preference of the user.

16. A global position system (GPS) real-time delivery system comprising:
a menu server, configured to store at least one menu of an establishment;
an establishment device of the establishment, configured to receive orders and customer information;
a mobile device, of a customer, configured to:
receive at least one menu from the menu server;
place an order from the at least one menu including order items and delivery information; and
provide customer information including real-time GPS information to the establishment device;
wherein the real-time GPS information is provided to the establishment device to adjust the order preparation start time.

17. The system of claim 16 wherein the delivery information is a specific location and the customer information further includes time estimates, wherein the time estimates provide an estimated time of arrival of the customer at a specific location.

18. The system of claim 16 wherein the delivery information includes a specific delivery time and the real-time GPS information enables the order to be delivered to the current location of the customer at the specific delivery time.

19. The system of claim 16 wherein the order is delivered by a drone, wherein the drone has an onboard computing device to receive the real-time GPS information for delivering the order to a current location of the customer.

20. The system of claim 16 wherein the establishment is a golf course and the customer is a patron of the golf course.
